(19) United States
(12) Patent Application Publication
(10) Pub. No.: US 2025/0100213 A1
(43) Pub. Date: Mar. 27, 2025

(54) COLOR FUSING AGENTS FOR THREE-DIMENSIONAL PRINTERS

(71) Applicant: Hewlett-Packard Development Company, L.P., Spring, TX (US)

(72) Inventors: Emre Hiro Discekici, San Diego, CA (US); Emily Levin, San Diego, CA (US); Jake H. Thomas, San Diego, CA (US)

(21) Appl. No.: 18/728,350

(22) PCT Filed: Jan. 19, 2022
(86) PCT No.: PCT/US2022/012886

§ 371 Date: Jul. 11, 2024

(51) Int. Cl. B29C 64/165; B29C 64/264; B33Y 10/00; B33Y 30/00; B33Y 70/00

(52) U.S. Cl. CPC B29C 64/165; B29C 64/264; B33Y 10/00; B33Y 30/00; B33Y 70/00; B29K 2995/0021

(57) ABSTRACT

In example implementations, a three-dimensional printing kit for printing a three-dimensional object in a three-dimensional printing system is provided. The three-dimensional printing kit includes a build material, a first colored fusing agent, and a second colored fusing agent. The first colored fusing agent includes water, a first solvent to provide a polymer plasticizer, a second solvent that is water miscible, a colored visible light absorber that absorbs a visible wavelength of light, wherein the colored visible light absorber comprises less than 3 weight percent of the first colored fusing agent, and a first colored dye. The second colored fusing agent includes water, the first solvent, the second solvent, the colored visible light absorber, and a second colored dye.

### BACKGROUND

Three-dimensional (3D) printing may include an additive printing process used to make three-dimensional solid parts from a digital model. 3D printing can be often used in rapid product prototyping, mold generation, mold master generation, and short run manufacturing. Some 3D printing techniques are considered additive processes because they involve the application of successive layers of material. This is unlike customary machining processes, which often rely upon the removal of material to create the final part. 3D printing can often use curing or fusing of the build material, which for some materials may be accomplished using heat-assisted extrusion, melting, or sintering.

### BRIEF DESCRIPTION OF THE DRAWINGS

FIG. 1 is a block diagram of an example three-dimensional printing kit in accordance with the present disclosure;

FIG. 2 is a block diagram of another example three-dimensional printing kit in accordance with the present disclosure;

FIG. 3 is a schematic illustration of an example three-dimensional printing system that uses the three-dimensional printing kit of the present disclosure;

FIG. 4 is a schematic illustration of another example three-dimensional printing system that uses the three-dimensional printing kit of the present disclosure;

FIG. 5 is a flowchart illustrating an example method of selectively applying the three-dimensional printing kit of the present disclosure on a build material to print a three-dimensional object; and

FIG. 6 illustrates a graph of absorption spectrum for different colored fusing agents.

### DETAILED DESCRIPTION

Examples described herein provide color fusing agents for three-dimensional (3D) printing. As discussed above, 3D printing may include an additive printing process that is used to make 3D solid parts from a digital model. 3D printing includes adding layers of build material. Layers of each object are “printed” in the build material with a fusing agent. The fusing agent absorbs light energy and converts the light energy into heat to heat a build material to a melting temperature of the build material. The build material can then be fused back together as the build material re-solidifies.

Some printing technologies, such as selective laser sintering (SLS) or multijet fusion (MJF) 3D printing, may print 3D parts using various build materials. These technologies use a tungsten bronze low tint fusing agent (LTFA) that is fused with near infrared (NIR) light sources. However, using fusing agents that do not include the LTFA and can absorb visible wavelengths to fuse the build material would reduce the cost of the printing device, since LTFAs are relatively expensive. In addition, using visible wavelength emitting light sources may reduce impact for powder degradation.

Printing technologies that use LTFA and NIR emitting light sources add color onto the periphery of the printed 3D object. For example, the object is printed, and then the color can be added on the exterior surface of the object. The added colors do not contribute to the fusing of the layers that are printed. Adding color to the periphery of the printed 3D object can cause complications such as dye leaching, fading, and other color-stability related concerns.

The present disclosure provides a color fusing agent that can be used with a visible wavelength emitting light source. The color fusing agent can be free of LTFA. The color fusing agent composition of the present disclosure allows lower amounts of the color absorber to be used due to the plasticizing content of the ink vehicle. Low concentrations of the color absorber in the fusing agent allows a variety of different colors to be created.

In addition, the color fusing agent of the present disclosure provides color to the printed 3D part via the color fusing agent itself. In other words, the desired colored fusing agents can be applied to layers of the 3D part to print the 3D printed object with the desired color or colors. The 3D printed part of the present disclosure may have less color leaching or fading than parts printed using previous methods that rely on a low concentration of LTFA to fuse on an outer surface of the printed parts. Since the outer surface may be less fused, leaching may be a problem in the previously used methods.

The colored fusing agents can also be formulated without using Carbon black. It has been found that Carbon black can negatively affect the physical/mechanical properties of the 3D printed part. Thus, using a colored fusing agent that does not contain carbon black may help improve the overall mechanical strength and properties of the 3D printed part.

Lastly, the colored fusing agents of the present disclosure may allow for formulation of different colored fusing agents that can be used with a single fusing lamp. For example, different colored fusing agents can be formulated by adding different amounts of a colored dye or different colored dyes with the colored visible light absorber. The additional colored dyes may have a different wavelength of absorption than the colored visible light absorber. Thus, the additional colored dyes may allow for different color formulations without affecting the performance of the colored fusing agent. A single type of fusing lamp (i.e., one wavelength of light) can then be used to heat the differently colored fusing agents after being applied to a layer of build material.

In addition, the relatively low amounts of the colored visible light absorber may allow different colored fusing agents to be formulated with the different colored dyes. For example, if a large amount of the colored visible light absorber were used, it would be more difficult to change the color of the colored fusing agent with small amounts of different colored dyes.

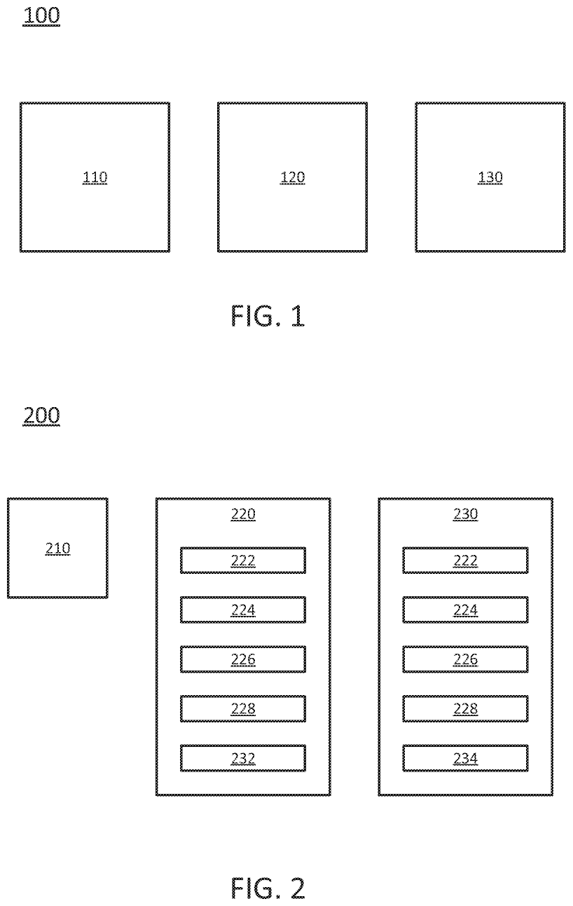

FIG. 1 illustrates a schematic illustration of an example three-dimensional printing kit 100 of the present disclosure. Three-dimensional printing kits can be used to make three-dimensional printed objects. A certain three-dimensional printing, or additive manufacturing, process can be performed using the materials described herein. In an example, different colored fusing agents can be applied to layers of the build material. Successive layers of the build material can be added, and the colored fusing agents can be applied on the layers to fuse the particles of the build material together to form layers of a three-dimensional printed part.

In an example, the three-dimensional printing kit 100 of the present disclosure may include a build material 110, a first colored fusing agent 120, and a second colored fusing agent 130. The build material 110 may be a powder. In an example, the build material 110 may be a polymer powder. Example build materials may include polyamides, modified polyamides, polyethylene, polyethylene terephthalate (PET), copolymer variations, and amorphous variations of these materials. Other example build materials include polystyrene, polyacetals, polypropylene, polycarbonate, polyester, polyurethanes, other engineering plastics, and blends of any two or more of the polymers listed herein.

In an example, when the build material is in a powder form, the build material may be made up of similarly sized particles or differently sized particles. Size, as used herein, refers to the diameter of a spherical particle, or the average diameter of a non-spherical particle. In some examples, the average size of the particles of the build material in the build material composition ranges from about 10 micrometer (μm) to about 100 μm or about 40 μm to about 50 μm. In some examples, the diameter or average diameter of the particles may be measured using an analytical chemical analysis. For example, the average diameter of the particles may be measured using a volume-based size distribution. The size of the particles may be measured by using a static light scattering technique, such as laser diffraction.

In an example, the first colored fusing agent 120 and the second colored fusing agent 130 may be different colors, but may absorb the same wavelength of visible light. This may promote similar fusing behavior despite drastically different final color properties.

In an example, the first colored fusing agent 120 and the second colored fusing agent 130 may include a colored visible light absorber that absorbs a visible wavelength of light. The visible wavelength of light may be between 400 nanometers (nm) to 780 nm. In an example, the visible wavelength of light may be approximately 455 nm.

Moreover, the first colored fusing agent 120 and the second colored fusing agent 130 may have an equivalent amount of absorbance at a particular wavelength of light. Thus, although the first colored fusing agent 120 and the second colored fusing agent 130 may be formulated to be different colors, a single wavelength of light may cause the first colored fusing agent 120 and the second colored fusing agent 130 to absorb an equivalent amount of energy.

For example, the first colored fusing agent 120 and the second colored fusing agent 130 may include an additional colored dye that may allow different color formulations for the first colored fusing agent 120 and the second colored fusing agent 130. The additional colored dye may have a different absorption wavelength. In other words, the additional colored dye does not absorb the same wavelength of light as the colored visible light absorber. As a result, the additional colored dye can be used to formulate different colored fusing agents without affecting the overall fusing behavior of the different colored fusing agents. FIG. 2 illustrates different formulations of the first colored fusing agent 120 and the second colored fusing agent 130.

FIG. 2 illustrates a schematic illustration of another example three-dimensional printing kit 200 of the present disclosure. In an example, three-dimensional printing kit 200 may include a build material 210, a first colored fusing agent 220, and a second colored fusing agent 230.

In an example, the build material 210 may be similar to the build material 110 illustrated in FIG. 1 and described above. In an example, the build material 210 may be a polymer or elastomer powder.

In an example, the first colored fusing agent 220 may include water 222 (e.g., deionized water), a first solvent 224 to provide a polymer plasticizer, a second solvent 226 that is water miscible, a colored visible light absorber 228 that absorbs a visible wavelength of light, and a first colored dye 232. In some instances, the colored visible light absorber 228 may act as the first colored dye 232. In other words, no additional colored dye may be used in the first colored fusing agent 220, as the colored visible light absorber 229 may provide the first color.

The second colored fusing agent 220 may be similar in composition to the first colored fusing agent 220 except that the second colored fusing agent 220 may include a second colored dye 234. For example, the second colored fusing agent 220 may include water 222, the first solvent 224, the second solvent 226, the colored visible light absorber 228, and a second colored dye 234.

The first solvent 224 may be a plasticizer and/or may have plasticizing characteristics when interacting with the build material 210. For example, the first solvent 224 may interact with the build material 210 to lower the melting temperature of the build material 210. The first solvent 224 may be an organic solvent, such as benzyl alcohol or diethylene glycol butyl ether (DEGBE).

The second solvent 226 may be a water miscible solvent that is compatible with the colored visible light absorber 228. The second solvent 226 may help keep the colored visible light absorber 228 dissolved in the water 222 and help provide stability and prevent aggregation of the colored visible light absorber 228 over time. In an example, the second solvent 226 may include at least one of diethylene glycol (DEG) butyl ether, 1,2-hexanediol, hydroxyethyl-2-pyrrolidone (HE2P), glycerol, propylene glycol and its oligomers, ethylene glycol and its oligomers, or 1,5-pentane diol.

In an example the colored visible light absorber 228 may be any colored light absorber that can absorb light with a visible wavelength. For example, the colored visible light absorber may absorb light having a wavelength of between 400 nm to 780 nm. In an example, the colored visible light absorber 228 may be a dye that absorbs light at approximately 455 nm. Some 3D printers may use fusing lamps that emit visible light at 455 nm. Thus, selecting a light absorber that absorbs light at a wavelength of approximately 455 nm may allow the first colored fusing agent 220 and the second colored fusing agent 230 to be compatible with existing 3D printers that use a fusing lamp that emits a visible wavelength of light around 455 nm. Examples of a colored visible light absorber that can absorb light having a wavelength of approximately 455 nm may include acid yellow 23 (AY-23), acid yellow 1, pyranine, and direct black 168 (DB-168)

In an example, the formulation of the first colored fusing agent 220 and the second colored fusing agent 230 with the first solvent 224 and the second solvent 226 may allow low amounts of the colored visible light absorber 228 to be used. For example, the colored visible light absorber 228 may be added in amounts as low as less than 0.05 weight percent (wt %) of a total weight of the first colored fusing agent 220 or a total weight of the second colored fusing agent 230. In an example, the colored visible light absorber 228 may be added at 0.75 wt %. In an example, the colored visible light absorber 228 may be added to an amount between 0.1 to 3 wt %. In an example, the colored visible light absorber 228 may be added to an amount between 2-3 wt %.

By using a relatively low amount of the colored visible light absorber 228, different colored fusing agents may be formulated by using small amounts of colored dyes that may not impact the fusing performance of the first colored fusing agent 220 and the second colored fusing agent 230. In addition, different colored fusing agents can be applied to a layer of the build material 210 and fused with light from a single type of fusing lamp that can use a single visible wavelength of light. For example, a desired wavelength of light to fuse the layers of the build material may be selected and the fusing lamp may be controlled to emit the selected wavelength of light. In other words, the different colored fusing agents of the present disclosure can be fused with a single wavelength of light rather than having to make multiple passes with different wavelengths of light to fuse the different colored fusing agents.

In an example, the first colored dye 232 and the second colored dye 234 may include small amounts of any color to achieve a desired color for the first colored fusing agent 220 and the second colored fusing agent 230, respectively. For example, the first colored dye 232 and the second colored dye 234 may be different colors. In another example, the first colored dye 232 and the second colored dye 234 may be the same color in different amounts to achieve different shades of color (e.g., a first amount of the first colored dye 232 mixed with the colored visible light absorber to formulate a “light red” and a second amount of the second colored dye 234 mixed with the colored visible light absorber to formulate a “dark red”). Examples of the first colored dye 232 and the second colored dye 234 may include C854, AY 17, Acid Red (AR) 52, AR 289, Reactive Red 180 (RR 180), Direct Blue (DB) 199, Pigment Blue (PB) 15:3, Pigment Red (PR) 122, Pigment Yellow (PY) 155, PY 74, and cesium tungsten oxide.

In an example, the first colored fusing agent 220 and the second colored fusing agent 230 may be formulated with the first solvent 224 in an amount of 10-40 wt %, the second solvent 226 in an amount of 30-60 wt %, the colored visible light absorber 228 in an amount of less than 3 wt %, and the additional colored dye (e.g., the first colored dye 232 or the second colored dye 234) in an amount of 0.10 to 3 wt %.

In an example, the first colored fusing agent 220 and the second colored fusing agent 230 may also include additional components, such as a surfactant. The surfactant may be added in an amount of 0.5 to 1 wt %. The surfactant may include a secondary alcohol ethoxylate, such as Tergitol™15-S-9, or other water-soluble non-ionic surfactants.

Example formulations are provided below of different colored fusing agents that can absorb visible wavelengths of light.

### Example 1—Cyan-Green

| Component | wt % |
|---|---|
| HE2P | 50 |
| Benzyl alcohol | 16 |
| AY-23 | 0.75 |
| C854 | 2.5 |
| Tergitol 15-S-9 | 0.8 |
| DI Water | balance |

### Example 2—Blue

| Component | wt % |
|---|---|
| 1,2-hexanediol | 36 |
| Benzyl alcohol | 30 |
| C854 | 0.75 |
| DB-168 | 0.1 |
| Tergitol 15-S-9 | 0.8 |
| DI Water | balance |

### Example 3—Magenta

| Component | wt % |
|---|---|
| HE2P | 50 |
| Benzyl alcohol | 16 |
| AY-23 | 0.75 |
| AR-52 | 0.75 |
| Tergitol 15-S-9 | 0.8 |
| DI Water | balance |

The example color formulations were used to print colored elastomers with an MJF printing process. The printed parts were soaked in water for several weeks and exhibited minimal color leaching. In addition, different colored dog bones were printed, and the tensile strength of the various printed dog bones were measured. The colored 3D printed part exhibited exceptionally high mechanical properties as illustrated by Table 1 below. Table 1 provides mechanical properties of 3D printed parts printed with a “peach” color (e.g., a yellow red combination of AY23 and AR52) under different printing conditions.

TABLE 1
TENSILE DATA OF DIFFERENT COLORED PRINTED PARTS

| | Tensile Strength | Young's Modulus | |
|---|---|---|---|
| Specimen | (MPa) | (MPa) | % Strain at Break |
| 1 | 7.681 | 54.0296 | 511.7 |
| 2 | 7.367 | 48.5983 | 567.96 |
| 3 | 7.953 | 35.8988 | 429.45 |
| 4 | 7.087 | 61.0898 | 269.89 |
| 5 | 6.966 | 59.1142 | 351.48 |
| 6 | 7.289 | 59.9675 | 285.89 |

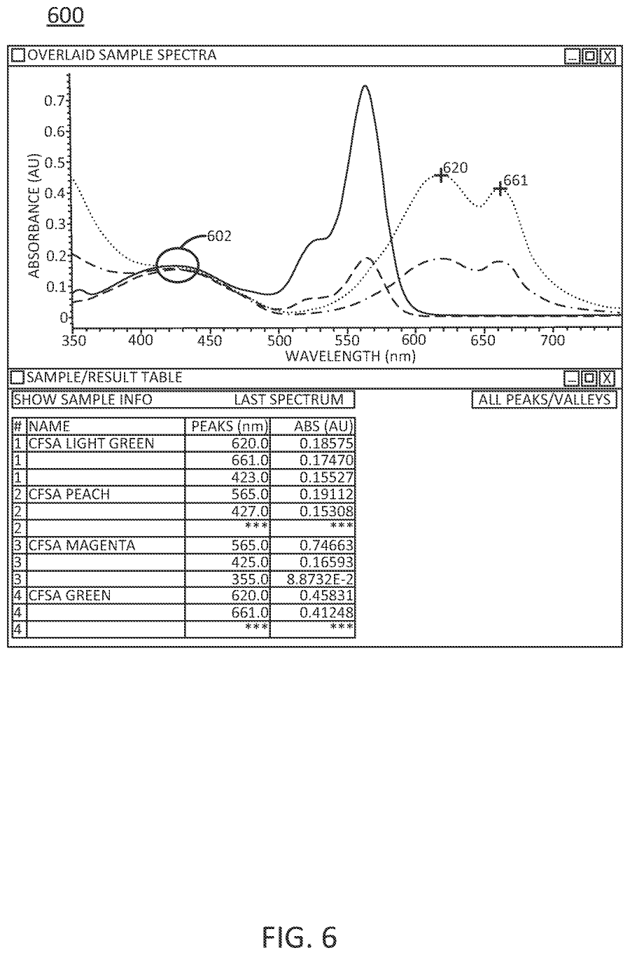

In addition, various colored fusing agents were prepared and tested to determine a wavelength of absorption. FIG. 6 illustrates a graph 600 of an absorption spectrum for different colored fusing agents. For example, a light green colored fusing agent, a peach colored fusing agent, a magenta colored fusing agent, and a green colored fusing agent were prepared using different amounts of colored dye in combination with water 222, the first solvent 224, the second solvent 226, and the colored visible light absorber 228, as described above. As can be seen around a point 602 in the graph 600, all of the differently colored fusing agents show an equivalent absorbance at 455 nm, which is the emission wavelength of certain 3D printers. Thus, despite having drastically different color properties as shown in the graph 600, all of the colored fusing agents may absorb light equally at approximately 455 nm.

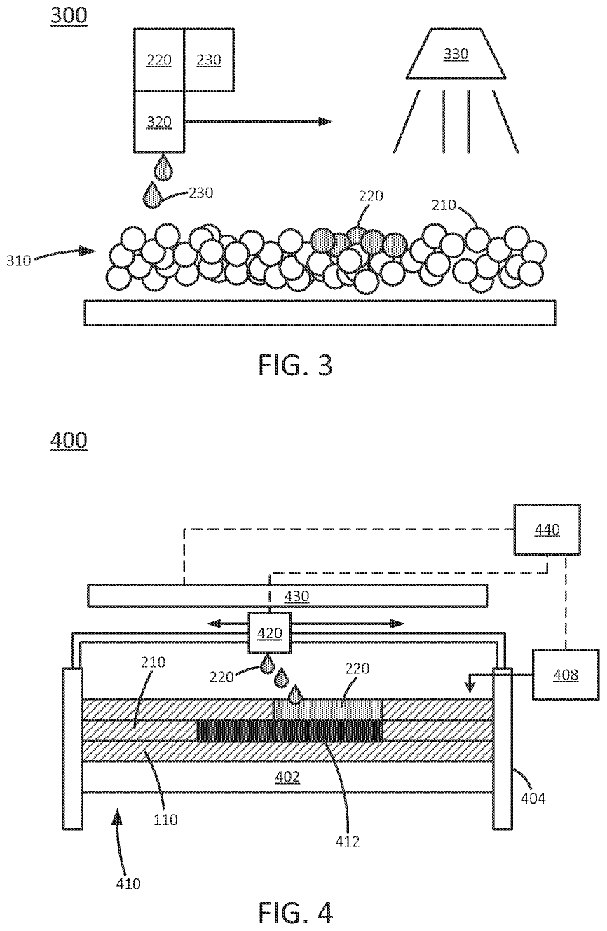

FIG. 3 illustrates an example of a three-dimensional printing system 300 that can use the three-dimensional printing kit 100 or 200 described above. The three-dimensional printing system 300 can be used with three-dimensional printing kit 100 or 200 described herein to make three-dimensional printed objects. In some examples, a three-dimensional printing system can include a powder bed for holding layers of the build material. A colored fusing agent applicator 320 can be positioned to selectively apply the first colored fusing agent 120 or 220 and the second colored fusing agent 130 or 230 onto the layers of build material 110 or 210. For example, the colored fusing agent applicator 320 can be controllable to apply the colored fusing agents at specific x/y coordinates of the layer of build material 310. Additionally, the three-dimensional printing system can include a fusing lamp. As used herein, “fusing” can refer to a process of heating the build material 110 or 210 and the colored fusing agents 120, 130, 220, or 230 so that build material is melted and then allowed to fuse back together when cooled.

In an example, the three-dimensional printing system 300 may include a powder bed 310. The example illustrated in FIG. 3 uses the build material 210 and the colored fusing agents 220 and 230. However, it should be noted that the three-dimensional printing system 300 may also use the build material 110 and the colored fusing agents 120 and 130. Although two different colored fusing agents are shown in FIG. 3, it should be noted that any number of colored fusing agents can be used, including a single colored fusing agent or more than two different colored fusing agents. For example, if a 3D part is to have four different colors, then four different colored fusing agents may be used with the color fusing agent applicator 320.

In an example, the powder bed 310 includes a layer of the build material 210. As noted above, the build material 210 includes particles of a polymer or elastomer. The printing system 300 may also include a color fusing agent applicator 320. The color fusing agent applicator 320 is fluidly coupled to a first colored fusing agent 220 and a second colored fusing agent 230. The color fusing agent applicator 320 can be controlled to iteratively apply the first colored fusing agent 220 and the second colored fusing agent 230 on desired locations of layers of the build material 210.

As shown in FIG. 3, the color fusing agent applicator 320 can apply the first colored fusing agent 220 on desired locations of the build material 210 and the second colored fusing agent 230 on desired locations of the build material 210. The color fusing agent applicator 320 may have different pens or different nozzles to eject the first colored fusing agent 220 and the second colored fusing agent 230 during a single pass.

The printing system 300 may also include a fusing lamp 330 positioned to emit wavelengths of light to be absorbed by the first colored fusing agent 220 and the second colored fusing agent 230. The fusing lamp 330 may emit light having a visible wavelength (e.g., between 400 nm to 780 nm). In an example, the fusing lamp 330 may emit light having a wavelength of approximately 455 nm. The absorbed light can be converted into heat to melt the particles of the build material 210.

In some examples, a detailing agent may also be used. Multi-jet fusion employs the detailing agent as a cooling agent that is applied to certain regions of the build to control thermals in the build bucket. The detailing agent is often printed in regions just superficial to the boundary of the part to prevent over fusing of surrounding powder onto the part edges. The detailing agent can also be applied within the body of large and bulky volumes within parts to prevent over temperature defects which can arise from excessive temperatures.

It should be noted that the three-dimensional printing system 300 has been simplified for ease of explanation and can include a variety of additional components besides the components shown in FIG. 3. Examples of additional components include a build material distributor, a supply of additional build material, a fluid applicator for applying an agent, a hardware controller to send instructions to other components in the system, a non-transitory computer readable medium having stored computer executable instructions to cause the hardware controller to send instructions to other components of the system to perform a three-dimensional printing method, a sintering oven, and the like.

FIG. 4 illustrates another example three-dimensional printing system 400. The example printing system 400 illustrated in FIG. 4 uses the build material 210, the first colored fusing agent 220 and the second colored fusing agent 230. However, the printing system 400 may also use the build material 110, the first colored fusing agent 120, and the second colored fusing agent 130.

In an example, the printing system 400 includes a powder bed 410 having a build material platform 402 and side walls 404. A build material applicator 408 is configured to deposit individual layers of the build material 210.

The printing system 400 may also include a colored fusing agent applicator 420 that is positioned above the powder bed 410. The colored fusing agent applicator 420 may be moveable so that the colored fusing agent applicator 420 can apply the first colored fusing agent 220 or the second colored fusing agent 230 on to the layers of the build material 210.

A fusing lamp 430 may be positioned to emit wavelengths of light that are absorbed by the colored fusing agents 220 and 230. The absorbed light can be converted into heat to heat the powder bed 410. In this example, the fusing lamp 430 may heat the individual layers of the build material 210 after the first colored fusing agent 220 and/or the second colored fusing agent 230 is applied to selective areas of a layer of the build material 210 to fuse the build material 210 to form each layer. The process may be repeated for each layer to print the 3D printed object layer by layer.

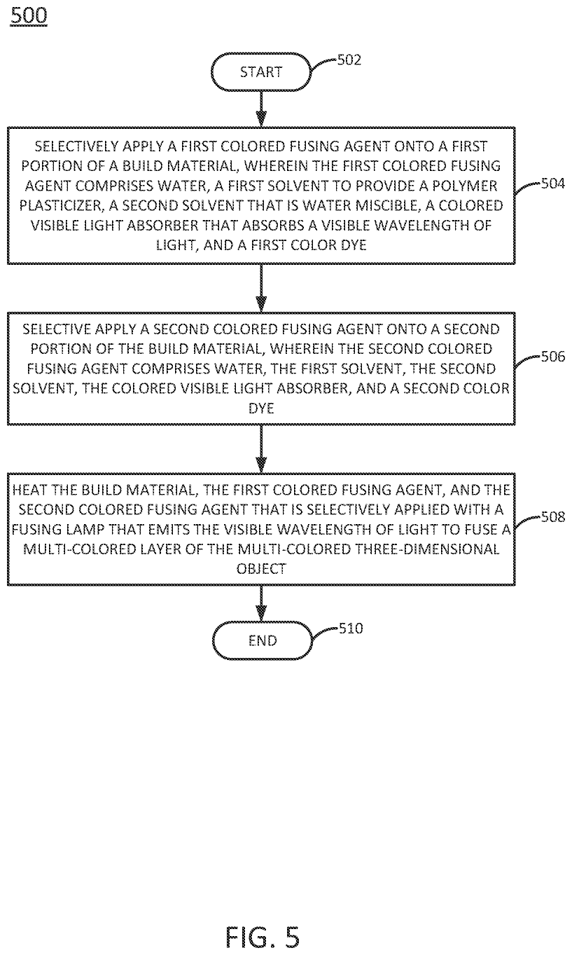

The printing system 400 may also include a hardware controller 440 or processor. The hardware controller 440 may communicate with the fusing lamp 430, the colored fusing agent applicator 420, and the build material applicator 408 to send instructions to the fusing lamp 430, the colored fusing agent applicator 420, and the build material applicator 408 to perform a three-dimensional printing method (e.g., the method 500 illustrated in FIG. 5, and described below).

In some examples, the colored fusing agent applicator 420 can be moveable along two axes, such as an x-axis and a y-axis, to allow the first colored fusing agent 220 and/or the second colored fusing agent 230 to be selectively applied to any desired location on the layers of build material 210. In other examples, the colored fusing agent applicator 420 can be large enough to extend across one entire dimension of the powder bed 410, and the colored fusing agent applicator 420 can be moveable along one axis.

For example, the colored fusing agent applicator 420 can include a plurality of nozzles along the length of the colored fusing agent applicator 420, and the first colored fusing agent 220 and/or the second colored fusing agent 230 can be selectively jetted from the individual nozzles assigned to a respective colored fusing agent. For example, the first colored fusing agent 220 may be jetted from a first nozzle and the second colored fusing agent 230 can be jetted from a second nozzle. The colored fusing agent applicator 420 can then scan across the powder bed 410, and the first colored fusing agent 220 and/or the second colored fusing agent 230 can be selectively jetted from the nozzles to allow the first colored fusing agent 220 and/or the second colored fusing agent 230 to be applied to any desired location on the powder bed 410.

In other examples, the powder bed 410 itself can be moveable. For example, the powder bed 410 can be moveable and the colored fusing agent applicator 420 can be stationary. In either example, the colored fusing agent applicator 420 and the powder bed 410 can be configured so that the first colored fusing agent 220 and/or the second colored fusing agent 230 can be selectively applied to specific portions of the powder bed 410.

The colored fusing agent applicator 420 can be configured to print drops of the first colored fusing agent 220 and/or the second colored fusing agent 230 at a resolution ranging from about 300 dots per inch (DPI) to about 1200 DPI in some examples. Higher resolutions or lower resolutions can also be used. The volume of individual drops of first colored fusing agent 220 and/or the second colored fusing agent 230 can be from about 1 Pico liters (pL) to about 400 pL in some examples. The firing frequency of nozzles of the binding agent applicator can be from about 1 kilohertz (kHz) to about 100 kHz in certain examples.

FIG. 5 illustrates a flow diagram of an example method 500 for selectively applying the three-dimensional printing kit on a build material to print a three-dimensional object of the present disclosure. In an example, the method 500 may be performed by the printing system 300 illustrated in FIG. 3 or the printing system 400 illustrated in FIG. 4 using the three-dimensional printing kit 100 illustrated in FIG. 1 or the three-dimensional printing kit 200 illustrated in FIG. 2.

At block 502, the method 500 begins. At block 504, the method 500 selectively applies a first colored fusing agent onto a first portion of a build material, wherein the first colored fusing agent comprises water, a first solvent to provide a polymer plasticizer, a second solvent that is water miscible, a colored visible light absorber that absorbs a visible wavelength of light, and a first color dye. For example, a layer of the build material may be deposited onto a powder bed. The build material may be leveled to provide a smooth, even layer of the build material.

The first colored fusing agent may be applied to desired locations on the layer of the build material. The desired locations may be based on a computer generated model of a three-dimensional object that is to be printed. The layer may represent a slice of the three-dimensional object. The desired locations may be based on the shape or design of the slice of the three-dimensional object that is to be printed for the current layer of build material.

In an example, the first colored fusing agent may include water, a first solvent to provide a polymer plasticizer, a second solvent that is water miscible, a colored visible light absorber that absorbs a visible wavelength of light, and a first color dye. The formulation/composition of the first colored fusing agent is discussed above and may be any one of the examples described herein.

At block 506, the method 500 selectively applies a second colored fusing agent onto a second portion of the build material, wherein the second colored fusing agent comprises water, the first solvent, the second solvent, the colored visible light absorber, and a second color dye. The second colored fusing agent may be similar in composition to the first colored fusing agent, but may include a second color dye that allows the second fusing agent to have a different color than the first fusing agent. The formulation/composition of the second colored fusing agent is discussed above and may be any one of the examples described herein.

In an example, the second color dye may be a different color dye than the first color dye. For example, the first color dye may be a green agent mixed with a yellow absorber to create a cyan colored fusing agent, and the second color dye may be a magenta agent mixed with a yellow absorber to create an orange colored fusing agent. In another example, the second color dye may be the same color as the first color dye, but in different amounts to generate different shades of a color. For example, a first amount of a red dye may be included in the first colored fusing agent to formulate an orange colored fusing agent and a second amount of the red dye may be included in the second colored fusing agent to formulate a maroon colored fusing agent.

At block 508, the method 500 heats the build material, the first colored fusing agent, and the second colored fusing agent that is selectively applied with a fusing lamp that emits the visible wavelength of light to fuse a multi-colored layer of the multi-colored three-dimensional object. For example, a single wavelength of light emitted by the fusing lamp may be used to fuse the build material with the different colors provided by the first colored fusing agent and the second colored fusing agent. The formulation of the first colored fusing agent and the second colored fusing agent may absorb the same wavelength of visible light even though the fusing agents have different colors. Thus, by formulating the different colored fusing agents to have an equivalent level of light absorbance at a particular wavelength of light, different colored fusing agents can be used with a single type of fusing lamp. The equivalent level of light absorbance by all of the different colored fusing agents may allow the build material to have similar fusing behavior across the entire area of a layer of the build material, even though different colored fusing agents are applied to different portions of each layer of the build material.

In some examples, the first colored fusing agent and the second colored fusing agent may be deposited on the same portion of the build material to create color gradients. For example, a portion of the build material may receive the first colored fusing agent. An adjacent portion of the build material may receive half of a total amount of fusing agent in the first colored fusing agent and half of the total amount of fusing agent in the second colored fusing agent. Then another adjacent portion of the build material may receive the second colored fusing agent. Thus, a gradient may be printed in the build material that gradually goes from the first colored fusing agent to the second colored fusing agent. It should be noted that the color gradient may be formed across layers of the 3D printed object as well.

The method 500 may repeat blocks 504, 506, and 508 for multiple layers. Each layer may include a bound portion that forms a portion of the three-dimensional object that is to be printed. The method 500 may then sinter the layers of the three-dimensional object that are bound to form a sintered three-dimensional printed object or the final form of the three-dimensional printed object. At block 510, the method 500 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A three-dimensional printing kit, comprising:
a build material;
a first colored fusing agent, comprising:
water;
a first solvent to provide a polymer plasticizer;
a second solvent that is water miscible; and
a colored visible light absorber that absorbs a visible wavelength of light, wherein the colored visible light absorber comprises less than 3 weight percent of the first colored fusing agent; and
a second colored fusing agent, comprising:
water;
the first solvent;
the second solvent;
the colored visible light absorber; and
a colored dye.

2. The three-dimensional printing kit of claim 1, wherein the first solvent comprises benzyl alcohol.

3. The three-dimensional printing kit of claim 1, wherein the second solvent comprises at least one of: diethylene glycol (DEG) butyl ether, 1,2-hexanediol, hydroxyethyl-2-pyrrolidone (HE2P), glycerol, propylene glycol, ethylene glycol, or 1,5-pentane diol.

4. The three-dimensional printing kit of claim 1, wherein the colored visible light absorber comprises between 0.1 to 3 weight percent of the first colored fusing agent and 0.1 to 3 weight percent of the second colored fusing agent.

5. The three-dimensional printing kit of claim 1, wherein the colored visible light absorber of the first colored fusing agent comprises approximately 0.75 weight percent of the first colored fusing agent and the colored visible light absorber of the second colored fusing agent comprises approximately 0.75 weight percent of the second colored fusing agent.

6. The three-dimensional printing kit of claim 1, wherein the colored dye comprises between 0.1 to 3 weight percent of the second colored fusing agent.

7. The three-dimensional printing kit of claim 1, wherein the first colored fusing agent comprises a colored dye, wherein the colored dye of the first colored fusing agent and the colored dye of the second colored fusing agent are different colors.

8. A three-dimensional printing system, comprising:
a powder bed comprising a layer of build material;
a colored fusing agent applicator fluidly coupled to a supply of a first colored fusing agent and a second colored fusing agent, wherein the colored fusing agent applicator is to iteratively apply the first colored fusing agent and the second colored fusing agent to the layer of build material, wherein the first colored fusing agent comprises a colored visible light absorber that absorbs a visible wavelength of light and a first color dye, and wherein the second colored fusing agent comprises the colored visible light absorber and a second colored dye; and
a fusing lamp positioned to emit light at the visible wavelength associated with the colored visible light absorber in the first colored fusing agent and the second colored fusing agent to heat the powder bed to a fusing temperature.

9. The three-dimensional printing system of claim 8, wherein the colored visible light absorber comprises an acid yellow-23 solution.

10. The three-dimensional printing system of claim 8, wherein the visible wavelength of light has a wavelength between 400 nanometers (nm) to 780 nm.

11. The three-dimensional printing system of claim 8, wherein the first colored dye of the first colored fusing agent and the second colored dye of the second colored fusing agent are different colors.

12. A method of printing a multi-colored three-dimensional object, comprising:
selectively applying a first colored fusing agent onto a first portion of a build material, wherein the first colored fusing agent comprises water, a first solvent to provide a polymer plasticizer, a second solvent that is water miscible, a colored visible light absorber that absorbs a visible wavelength of light, and a first color dye;
selectively applying a second colored fusing agent onto a second portion of the build material, wherein the second colored fusing agent comprises water, the first solvent, the second solvent, the colored visible light absorber, and a second color dye; and
heating the build material, the first colored fusing agent, and the second colored fusing agent that is selectively applied with a fusing lamp that emits the visible wavelength of light to fuse a multi-colored layer of the multi-colored three-dimensional object.

13. The method of claim 12, wherein a wavelength of the visible wavelength of light comprises 455 nanometers (nm).

14. The method of claim 12, wherein the colored visible light absorber comprises 0.1 to 3 weight percent of the first colored fusing agent and 0.1 to 3 weight percent of the second colored fusing agent.

15. The method of claim 12, wherein the selectively applying the first colored fusing agent, the selectively applying the second colored fusing agent, and the heating are repeated for a plurality of layers until printing of the multi-colored three-dimensional printed object is completed.
